(19) United States
(12) Patent Application Publication
(10) Pub. No.: US 2012/0294628 A1
(43) Pub. Date: Nov. 22, 2012

(54) LIGHT SOURCE UNIT AND COMMUNICATION APPARATUS

(75) Inventor: Masakazu Ukita, Kanagawa (JP)

(73) Assignee: SONY CORPORATION, Tokyo (JP)

(21) Appl. No.: 13/522,856

(22) PCT Filed: Dec. 24, 2010
(86) PCT No.: PCT/JP2010/073304

§ 371 Date: Jul. 18, 2012

(30) Foreign Application Priority Data
Jan. 25, 2010 (JP) 2010-013669

(51) Int. Cl. F21V 7/00; H04B 10/04; G02F 1/13357; F21V 9/00; F21V 13/08

(52) U.S. Cl. 398/201; 362/259; 362/19; 315/151; 349/33

(57) ABSTRACT

To provide a small light source unit that can be used for quantum encryption communication. Provided is a light source unit including a first reflector having a reflectance R₁, a second reflector arranged opposite to the first reflector and having a reflectance R₂ (R₂<R₁), a laser medium arranged between the first reflector and the second reflector, and an excitation source to excite the laser medium, wherein the reflectance R₁ is set in such a way that the number of photons of laser light having passed through the first reflector is one per pulse.

### TECHNICAL FIELD

The present invention relates to a light source unit and a communication apparatus.

### BACKGROUND ART

With rapid development of information processing technology and communication technology, digitization of documents are in progress at a rapid pace regardless of whether documents are public documents or private documents. Accordingly, many individuals and enterprises show a keen interest in safety management of electronic documents. With such a mounting interest, safety from tampering acts such as eavesdropping and forgery of electronic documents are increasingly discussed in many quarters. Safety of an electronic document from eavesdropping can be secured by, for example, encrypting the electronic document. Also, safety of an electronic document from forgery can be secured by, for example, using an electronic signature. However, sufficient resistance to tampering is demanded from encryption and electronic signatures.

Safety of public key encryption systems currently used widely is grounded on computational complexity of a classical computer. For example, safety of the RSA encryption is grounded on “difficulty of factorization of a large composite number into prime numbers (hereinafter, called a factorization problem)”. Also, safety of the DSA encryption or ElGamal encryption is grounded on “difficulty of a solution to a discrete logarithmic problem”. However, a quantum computer is said to be able to efficiently calculate a solution to a factorization problem or discrete logarithmic problem. That is, safety of the above encryption systems currently used widely is no longer guaranteed if the quantum computer becomes commercially available.

Against the background of such circumstances, research on quantum cryptography using a quantum computer and research on a quantum key distribution protocol using a quantum communication path are actively pursued. The above expression of “classical” is used in a sense of not being “quantum”. The expression of “quantum” means that the principle of quantum mechanics is conformed to or applied. For example, the principle of superposition in quantum mechanics is used. Also, the quantum key distribution protocol uses the uncertainty principle of quantum mechanics.

A typical example of the quantum key distribution protocol is the BB84 protocol. Also, a quantum key distribution protocol obtained by improving the BB84 protocol is known. In these quantum key distribution protocols, transmitting 1-bit information by one photon is considered as a condition for guaranteeing difficulty of eavesdropping. Thus, to secure safety in the quantum key distribution protocols, it is necessary to strictly control the number of photons of each pulse emitted from a light source unit so that one photon is present in one pulse. However, the number of photons emitted from the light source unit such as a semiconductor laser has the Poisson distribution and even if the average number of photons per pulse is limited to one photon, a pulse containing two or more photons is generated with a finite probability.

That is, to realize a quantum key distribution protocol, a light source unit capable of generating a feeble optical pulse in which noise is low and intensity is sufficiently controlled is demanded. In many cases, a laser light source is used as a low-noise light source unit. Particularly, a semiconductor laser is frequently used due to ease of handling and lower prices. Though not intended for application to quantum key distribution protocols, Patent Literature 1 describes a general configuration of a semiconductor laser. The semiconductor laser described therein enables monitoring of light output from a rear end surface by setting a reflectance R_{f} of a front end surface constituting an optical resonator and the reflectance Rᵣ of the rear end surface to different values (R_{f}<Rᵣ).

### CITATION LIST

### Patent Literature

Patent Literature 1: Japanese Patent No. 2666086

### SUMMARY OF INVENTION

### Technical Problem

However, it is difficult to obtain light in which the average number of photons per pulse is one or less by using a laser light source currently in use. If, for example, the length of an optical pulse containing one photon of the wavelength 1.5 μm is 1 ns, the energy of the optical pulse is 1.3×10⁻¹⁹J. The average power thereof is 0.13 nW. However, it is difficult to such a feeble optical pulse by using the semiconductor laser described in the above literature. Also, if an attempt is made to obtain a feeble optical pulse as described above by combining the semiconductor laser described in the above literature with an attenuator or the like, it will be necessary to install a relatively large facility, leading to a huge size of the light source unit itself.

The present invention is made in view of the above issue and an object of the present invention is to provide a small light source unit that can be used for quantum encryption communication and a communication apparatus capable of transmitting/receiving data by using the light source unit.

### Solution to Problem

According to one aspect of the present invention in order to achieve the above-mentioned object, there is provided a light source unit, including: a first reflector having a reflectance R₁; a second reflector arranged opposite to the first reflector and having a reflectance R₂ (R₂<R₁); a laser medium arranged between the first reflector and the second reflector; and an excitation source to excite the laser medium, wherein the reflectance R₁ is set in such a way that the number of photons of laser light having passed through the first reflector is one per pulse.

According to another aspect of the present invention in order to achieve the above-mentioned object, there is provided a light source unit, including: a first reflector having a reflectance R₁; a second reflector arranged opposite to the first reflector and having a reflectance R₂ (R₂<R₁); a laser medium arranged between the first reflector and the second reflector; an excitation source to excite the laser medium; and an optical attenuator that causes laser light having passed through the first reflector to attenuate, wherein the reflectance R₁ is set in such a way that the number of photons of the laser light attenuated by the optical attenuator is one per pulse.

According to another aspect of the present invention in order to achieve the above-mentioned object, there is provided a light source unit, including: a first reflector having a reflectance R₁; a second reflector arranged opposite to the first reflector and having a reflectance R₂ (R₂<R₁); a laser medium arranged between the first reflector and the second reflector; an excitation source to excite the laser medium; a photo-detector that detects intensity of laser light having passed through the second reflector; and a controller that controls the excitation source to adjust excitation intensity for the laser medium based on the intensity of the laser light detected by the photo-detector in such a way that the number of photons of the laser light having passed through the first reflector is one per pulse.

According to another aspect of the present invention in order to achieve the above-mentioned object, there is provided a light source unit, including: a first reflector having a reflectance R₁; a second reflector arranged opposite to the first reflector and having a reflectance R₂ (R₂<R₁); a laser medium arranged between the first reflector and the second reflector; an excitation source to excite the laser medium; an optical attenuator that causes laser light having passed through the first reflector to attenuate; a photo-detector that detects intensity of the laser light having passed through the second reflector; and a controller that controls the excitation source to adjust excitation intensity for the laser medium based on the intensity of the laser light detected by the photo-detector in such a way that the number of photons of the laser light attenuated by the optical attenuator is one per pulse.

According to another aspect of the present invention in order to achieve the above-mentioned object, there is provided a light source unit, including: a first reflector having a reflectance R₁; a second reflector arranged opposite to the first reflector and having a reflectance R₂ (R₂<R₁); a laser medium arranged between the first reflector and the second reflector; an excitation source to excite the laser medium; an optical attenuator that causes laser light having passed through the first reflector to attenuate; a photo-detector that detects intensity of the laser light having passed through the second reflector; and a controller that controls a magnitude of attenuation of the laser light by the optical attenuator to a first magnitude of attenuation in which the number of photons of the laser light attenuated by the optical attenuator is one per pulse or a second magnitude of attenuation that is different from the first magnitude of attenuation based on the intensity of the laser light detected by the photo-detector.

The laser medium may be a laser medium of a semiconductor laser.

An optical resonator configured by the first and second reflectors may be formed of a Fabry-Perot resonator. In this case, one or both of the first and second reflectors are semiconductor end faces coated with a dielectric film.

An optical resonator configured by the first and second reflectors may be a distributed feedback resonator or a distributed Bragg reflection resonator.

An optical resonator configured by the first and second reflectors may be a multilayer mirror resonator. In this case, the semiconductor laser is a surface light emitting laser.

The photo-detector may be a semiconductor light-receiving element.

The optical attenuator may be an optical filter, a partial reflection mirror, or a combination of the optical filter and the partial reflection mirror.

The laser medium may output the laser light linearly polarized in a first polarization direction. In this case, the optical attenuator includes: a liquid crystal device that changes a polarization direction of the laser light output from the laser medium to an extent of change in accordance with an applied voltage; and a polarizing plate that transmits light in a second polarization direction perpendicular to the first polarization direction, the light having passed through the liquid crystal device enters the polarizing plate, and the controller controls a magnitude of attenuation of the laser light by the optical attenuator by controlling the voltage applied to the liquid crystal device.

According to another aspect of the present invention in order to achieve the above-mentioned object, there is provided a communication apparatus, including: a light source unit including: a first reflector having a reflectance R₁; a second reflector arranged opposite to the first reflector and having a reflectance R₂ (R₂<R₁); a laser medium arranged between the first reflector and the second reflector; and an excitation source to excite the laser medium; and a data transmitting unit that transmits data by using the light source unit, wherein the reflectance R₁ is set in such a way that the number of photons of laser light having passed through the first reflector is one per pulse.

### Advantageous Effects of Invention

According to the present invention, as described above, a light source unit that can be used for quantum encryption communication can be made smaller in size.

### BRIEF DESCRIPTION OF DRAWINGS

FIG. 1 is an explanatory view illustrating the configuration of a light source unit according to a first embodiment of the present invention.

FIG. 2 is an explanatory view illustrating the configuration of the light source unit according to a modification of the embodiment.

FIG. 3 is an explanatory view illustrating a setting method of a reflectance in the light source unit according to the embodiment.

FIG. 4 is an explanatory view illustrating the configuration of the light source unit according to a second embodiment of the present invention.

FIG. 5 is an explanatory view illustrating the configuration of the light source unit according to a modification of the embodiment.

FIG. 6 is an explanatory view illustrating the configuration of the light source unit according to a third embodiment of the present invention.

FIG. 7 is an explanatory view illustrating the configuration of a variable optical attenuator according to the embodiment.

FIG. 8 is an explanatory view illustrating a concrete application example of the light source unit according to the embodiment.

FIG. 9 is an explanatory view illustrating a concrete application example of the light source unit according to the embodiment.

FIG. 10 is an explanatory view illustrating a concrete application example of the light source unit according to the embodiment.

FIG. 11 is an explanatory view illustrating a concrete application example of the light source unit according to the embodiment.

FIG. 12 is an explanatory view illustrating the configuration of a general laser light source used for quantum encryption communication.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

### [Flow of the Description]

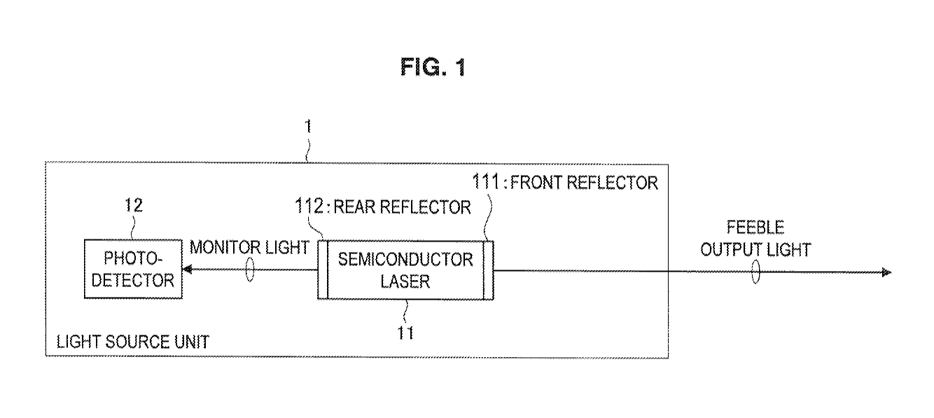

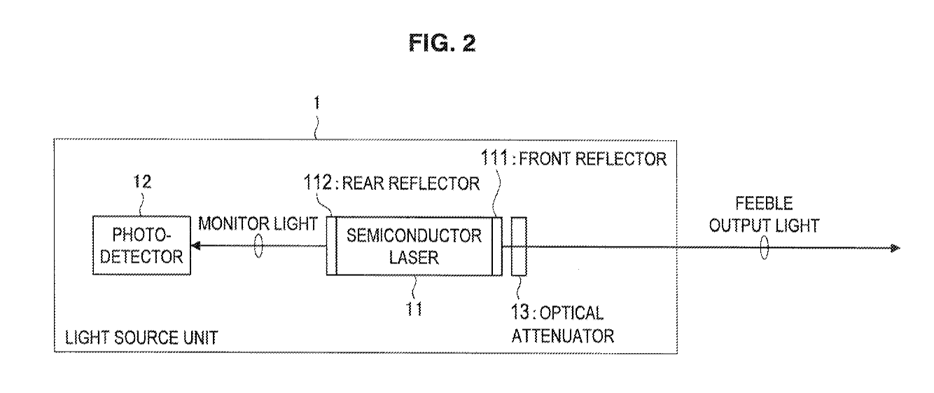

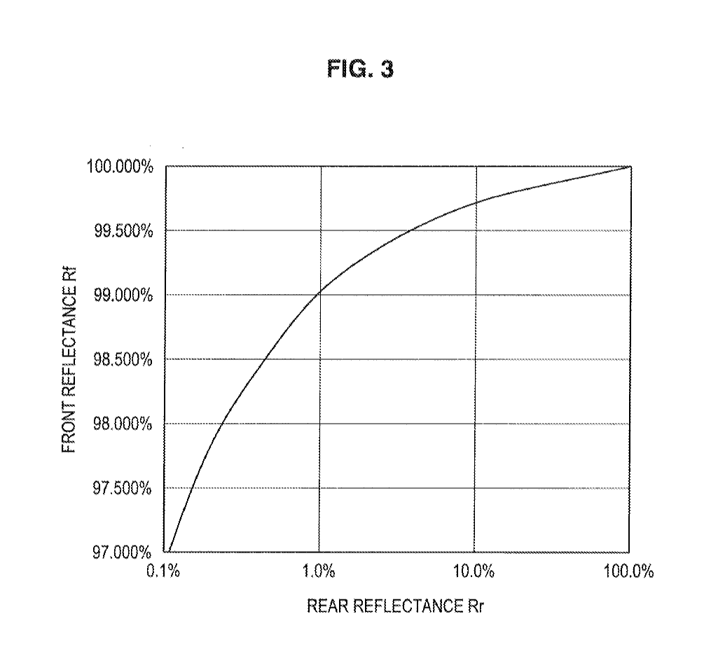

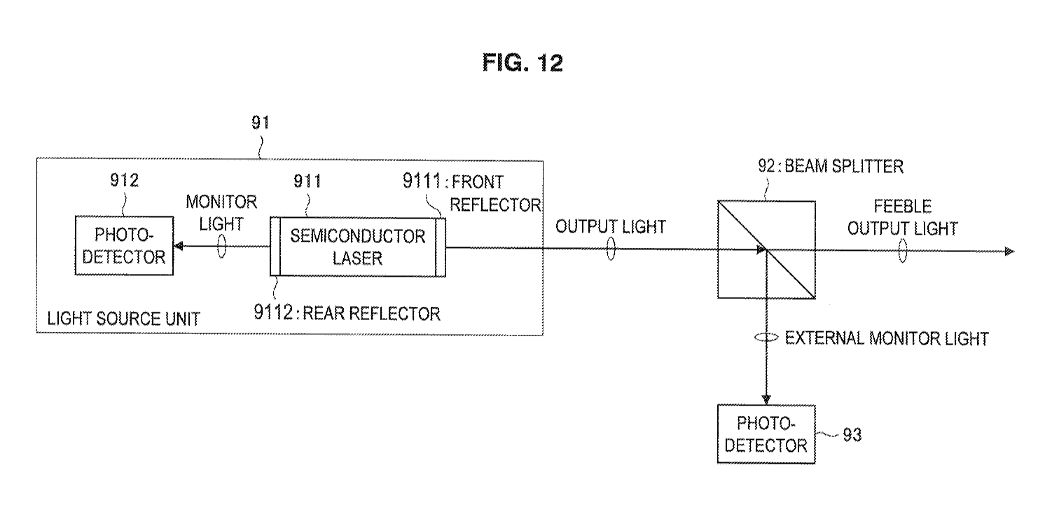

The flow of the description about the embodiments of the present invention described below will briefly be described. First, the configuration of a conventional light source unit 91 will be described with reference to FIG. 12. Next, the configuration of a light source unit 1 according to the first embodiment of the present invention will be described with reference to FIG. 1. Next, the configuration of the light source unit 1 according to a modification of the embodiment will be described with reference to FIG. 2. Next, the setting method of the reflectance of the light source unit 1 according to the embodiment will be described with reference to FIG. 3.

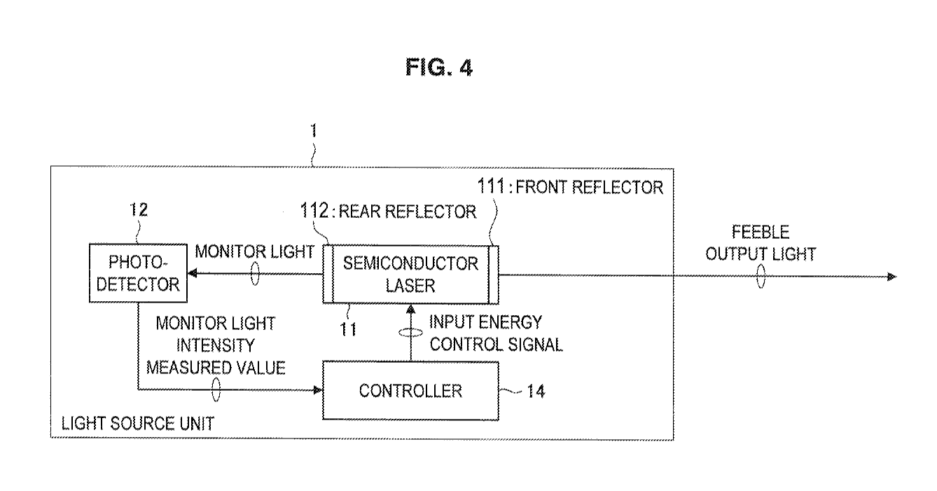

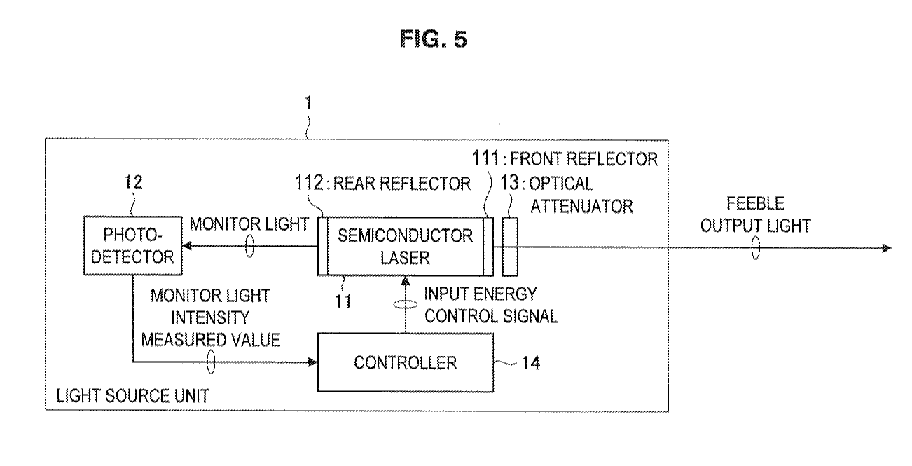

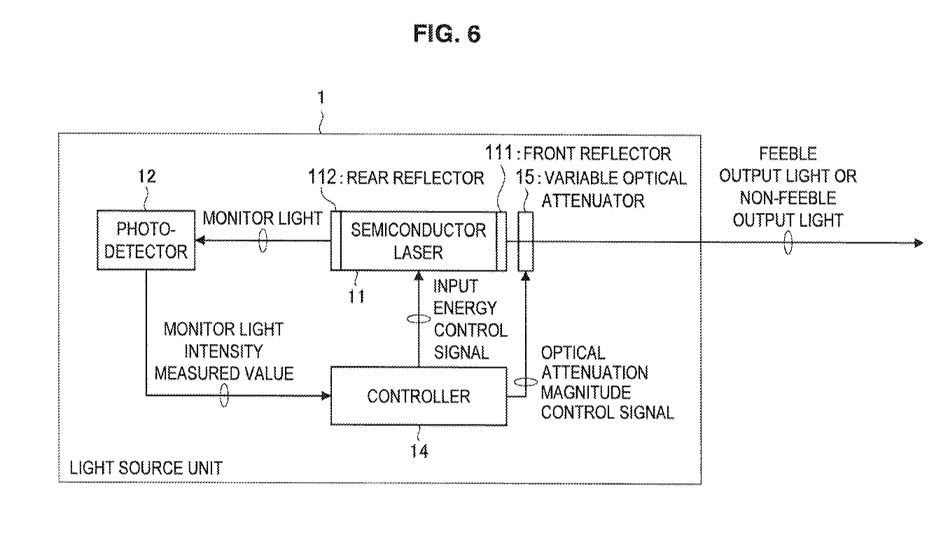

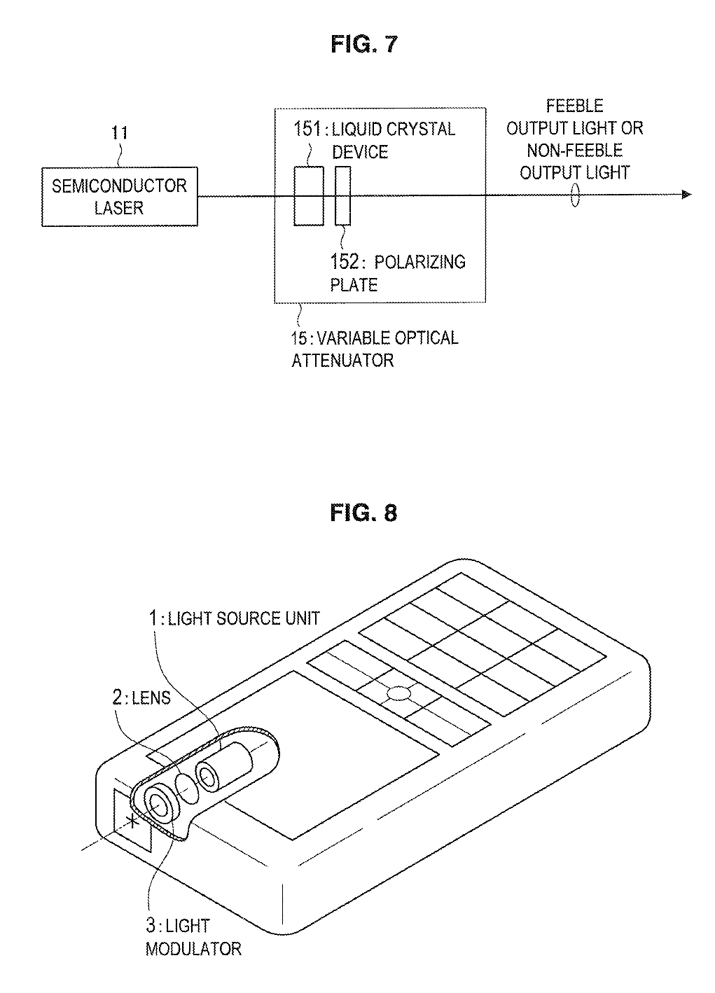

Next, the configuration of the light source unit 1 according to the second embodiment of the present invention will be described with reference to FIG. 4. Next, the configuration of the light source unit 1 according to a modification of the embodiment will be described with reference to FIG. 5. Next, the configuration of the light source unit 1 according to the third embodiment of the present invention will be described with reference to FIG. 6. Next, the configuration of a variable optical attenuator 15 according to the embodiment will be described with reference to FIG. 7. Next, application examples of the light source unit 1 according to the embodiment will be described with reference to FIGS. 8 to 11. Lastly, technical ideas of the embodiments will be summarized and operation effects obtained from the technical ideas will briefly be described.

### Description Items

1: Introduction

2: First embodiment

2-1: Configuration of the light source unit 1

2-2: Modification (configuration provided with an optical attenuator 13)

3: Second embodiment (application of a controller 14)

3-1: Configuration of the light source unit 1

3-2: Modification (configuration provided with the optical attenuator 13)

4: Third embodiment (application of the variable optical attenuator 15)

4-1: Configuration of the light source unit 1

4-2: Concrete application examples of the light source unit I

5: Conclusion

### <1. Introduction>

An object of the embodiments described below is to provide a light source unit capable of generating a low-noise feeble light used for quantum encryption communication by using a laser light source. It is necessary to attenuate light to such an extent that the average number of photons per pulse is one or less so that the light can be used for quantum encryption communication. If, for example, the length of an optical pulse containing one photon of the wavelength 1.5 μm is 1 ns, the energy of the optical pulse is 1.3×10⁻¹⁹J. The average power thereof is 1.3×10⁻¹⁰ W=0.13 nW. Such a feeble light cannot be obtained from a semiconductor laser currently in use. To obtain such a feeble light by using a semiconductor laser currently in use, a large-scale facility as shown, for example, in FIG. 12 is needed.

The configuration of a light source system constructed by using a semiconductor laser currently in use to obtain a feeble light as described above will be described with reference to FIG. 12. The light source system includes, as shown in FIG. 12, the light source unit 91, a beam splitter 92, and a photo-detector 93. The light source unit 91 includes a semiconductor laser 911 and a photo-detector 912. Further, the semiconductor laser 911 is provided with a front reflector 9111 and a rear reflector 9112 forming an optical resonator.

The semiconductor laser 911 contains a laser medium and an excitation source. The excitation source is an energy input source that excites atoms in the laser medium by inputting a current or light (hereinafter, referred to as energy) into the laser medium. If energy is input into the laser medium from the excitation source and the energy exceeds an oscillation threshold of the laser medium, the semiconductor laser 911 oscillates as a laser. Light emitted from the laser medium is amplified by being repeatedly reflected between the front reflector 9111 and the rear reflector 9112 before being output from the front reflector 9111 and the rear reflector 9112.

The reflectance Rf of the front reflector 9111 is set to be smaller than the reflectance Rr of the rear reflector 9112. Thus, a strong light (output light) is output from the front reflector 9111 and a feeble light (monitor light) is output from the rear reflector 9112. The monitor light output from the rear reflector 9112 enters the photo-detector 912.

In the current semiconductor laser 91, the reflectance R_{f} of the front reflector 9111 and the reflectance 9112 of the rear reflector 9112 are set so that the relation R_{f}≦Rᵣ (preferably R_{f}<Rᵣ and particularly preferably R_{f}<<Rᵣ) holds herebetween to make the intensity of the output light as high as possible.

Generally, the relation shown in the following formula (1) holds between intensity Pf of output light and intensity Pr of monitor light by using the reflectance

Rf of the front reflector 9111 and the reflectance Rr of the rear reflector 9112. The following formula (1) can be transformed like the following formula (2). Further, if the following formula (2) is rewritten by using a function f(x)≡(1/x−x), the formula (1) can be expressed like the following formula (3).

The f(x) monotonously decreases in the range of 0<x≦1. Thus, if R_{f}<Rᵣ, f(R_{f}^{1/2})>f(Rᵣ^{1/2}) is obtained and it is clear from the following formula (3) that P_{f}/Pᵣ>1 holds. That is, if the reflectance Rf of the front reflector 9111 is smaller than the reflectance Rr of the rear reflector 9112 (R_{f}<Rᵣ), the intensity Pf of the output light becomes higher than the intensity Pᵣ of the monitor light (P_{f}>Pᵣ).

$$\begin{matrix}[ Math 1 ] & \\ \frac{{P}_{f}}{{P}_{r}} = \sqrt{\frac{{R}_{r}}{{R}_{f}}} \times \frac{1 - {R}_{f}}{1 - {R}_{r}} & ( 1 ) \\ \frac{{P}_{f}}{{P}_{r}} = \frac{1 / \sqrt{{R}_{f}} - \sqrt{{R}_{f}}}{1 / \sqrt{{R}_{r}} - \sqrt{{R}_{r}}} & ( 2 ) \\ \frac{{P}_{f}}{{P}_{r}} = \frac{f ( \sqrt{{R}_{f}} )}{f ( \sqrt{{R}_{r}} )} & ( 3 )\end{matrix}$$

However, if the reflectance R_{f} of the front reflector 9111 and the reflectance Rᵣ of the rear reflector 9112 are equal (R_{f}=Rᵣ), f(R_{f}^{1/2})=f(Rᵣ^{1/2}) is obtained and the intensity P_{f} of the output light becomes equal to the intensity Pᵣ of the monitor light (P_{f}=Pᵣ). The intensity of output light emitted from the semiconductor laser 911 is about 1 mW or more. Thus, to attenuate the intensity of output light emitted from the semiconductor laser 911 to 1 nW or less, the beam splitter 92 (for a filter) having a suitable transmittance is needed.

In the light source system exemplified in FIG. 12, the output light output from the semiconductor laser 911 enters the beam splitter 92. The light having passed through the beam splitter 92 becomes a feeble output light by being weakened by the beam splitter 92. On the other hand, the light reflected by the beam splitter 92 becomes an external monitor light with relatively high intensity.

Also, a configuration in which transmitted light of the beam splitter 92 becomes an external monitor light and light reflected by the beam splitter 92 becomes a feeble output light by changing the setting of the beam splitter 92 can also be considered. The beam splitter 92 may be a polarization beam splitter. Further, instead of the beam splitter 92, an absorption filter may be set up. In this case, a feeble output light can be obtained, but no external monitor light can be obtained.

Instead of the beam splitter 92, a polarizing plate may be set up. In this case, a feeble output light can be extracted by tilting the optical axis of the polarizing plate from the polarization direction possessed by output light from the semiconductor laser 911. Further, a configuration in which a feeble output light attenuated sufficiently is obtained by setting up a plurality of the beam splitters 92 (or the filters) may also be adopted.

The external monitor light obtained from the beam splitter 92 enters the photodetector 93. The photo-detector 93 entered by the external monitor light detects intensity of the external monitor light. The intensity of the external monitor light detected by the photo-detector 93 is used for control of energy input into the laser medium in the semiconductor laser 911. If, for example, input energy is controlled so that the intensity of the external monitor light detected by the photo-detector 93 is stabilized, the intensity of feeble output light output from the beam splitter 92 can be stabilized to reduce noise.

If, instead of the beam splitter 92, an absorption filter or the like is set up, no external monitor light can be obtained, but in this case, input energy may be controlled by using the intensity of monitor light detected by the photo-detector 912. However, the intensity of monitor light is frequently lower than the intensity of external monitor light. As a result, detection accuracy of monitor light becomes lower than detection accuracy of external monitor light. Thus, to stabilize the intensity of feeble output light, it is preferable to detect the intensity of external monitor light by using, as shown in FIG. 12, the beam splitter 92 and the photo-detector 93 to use the detection result for control of input energy.

In the example in FIG. 12, the intensity of output light is attenuated by using the beam splitter 92 set up outside the light source unit 91. However, a method of, for example, reducing energy input into the laser medium of the semiconductor laser 911 can be considered as a method of attenuating the intensity of output light. In the output light of the semiconductor laser 911, however, spontaneous emission light is contained regardless of whether laser oscillation is present. Spontaneous emission light is a noise component for laser light. If the intensity of output light should be reduced to 1 nW or less by limiting input energy, the ratio of spontaneous emission light to output light increases. Moreover, if input energy is reduced to obtain a feeble output light of 1 nW or less, laser oscillation itself may not occur or may become unstable.

For such reasons, it is difficult to control the intensity of output light emitted from the semiconductor laser 911 to the intensity of a feeble output light. Therefore, it is necessary to provide an optical attenuation unit such as the beam splitter 92 to obtain a feeble output light by using the semiconductor laser 911 currently in use. Consequently, it is difficult to reduce the light source system in size to obtain a feeble output light used for quantum encryption communication. The technology according to the embodiments described below is devised in view of the above issue and provides a small light source unit capable of generating a low-noise feeble output light with stability by using a laser light source.

### 2. First Embodiment

The first embodiment of the present invention will be described.

### [2-1: Configuration of the Light Source Unit 1]

First, the configuration of the light source unit 1 according to the present embodiment will be described with reference to FIG. 1. FIG. 1 is an explanatory view illustrating the configuration of the light source unit 1 according to the present embodiment.

As shown in FIG. 1, the light source unit 1 includes a semiconductor laser 11 and a photo-detector 12. The semiconductor laser 11 is also provided with a front reflector 111 and a rear reflector 112 as an optical resonator. Optical resonators that can be applied to the semiconductor laser 11 include, for example, a Fabry-Perot resonator obtained by coating an end face of the semiconductor laser 11 with a dielectric multilayer. Also, a DFB resonator (distributed feedback resonator) obtained by incorporating a Bragg reflection mechanism into the semiconductor laser 11, a DBR resonator (distributed inversion resonator) obtained by, like a surface light emitting laser, alternately stacking semiconductors having different indexes of refraction and the like are also used.

The reflectance R_{f} (hereinafter, referred to as the front reflectance R_{f}) of the front reflector 111 is set to be larger than the reflectance Rᵣ (hereinafter, referred to as the rear reflectance Rᵣ) of the rear reflector 112 (R_{f}>Rᵣ). Thus, a strong light (monitor light) is output from the rear reflector 112 and a weak light (output light) is output from the front reflector 111.

The relation shown in the above formula (1) holds between the intensity Pᵣ of output light and the intensity P_{f} of monitor light by using the front reflectance R_{f} and the rear reflectance Rᵣ. If R_{f}>fᵣ holds, f(R_{f}^{1/2})>f(Rᵣ^{1/2}) is obtained and it is clear from the above formula (3) that P_{f}/Pᵣ<1 holds. That is, if the front reflectance R_{f} is larger than the rear reflectance Rᵣ (R_{f}>Rᵣ), the intensity P_{f} of output light becomes lower than the intensity Pᵣ of monitor light (P_{f}<Pᵣ). Thus, the light source unit 1 outputs high-intensity monitor light from the rear reflector 112 and low-intensity output light from the front reflector 111.

The monitor light output from the rear reflector 112 enters the photo-detector 12. The photo-detector 12 detects the intensity of the monitor light that has entered the photo-detector 12. As the photo-detector 12, for example, a semiconductor light-receiving element such as a photodiode is used. The surface of the photo-detector 12 is preferably antireflection-coated. Further, the photo-detector 12 is preferably set up by being tilted obliquely with respect to the plane of incidence of monitor light.

With the configuration described above, a portion of the incident monitoring light will not be reflected to return to the semiconductor laser 11. If reflected light of monitor light returns to the semiconductor laser 11, the operation of the semiconductor laser 11 becomes unstable, but by adopting the above configuration, a factor that makes the operation of the semiconductor laser 11 unstable is eliminated. As a result, the operation of the semiconductor laser 11 is stabilized and noise added to output light is inhibited.

On the other hand, light output from the front reflector 111 is extracted from the light source unit 1 as a feeble output light. The intensity of the feeble output light is adjusted by controlling input energy of the semiconductor laser 11. The light source unit 1 also controls energy input into the semiconductor laser 11 so that the intensity of the feeble output light is stabilized in accordance with the intensity of the monitor light detected by the photo-detector 12. The control of energy input into the semiconductor laser 11 is realized by, for example, controlling a power supply to drive the semiconductor laser 11.

### (Settings of the Reflectance R_{f}, Rᵣ)

The setting method of the front reflectance R_{f} and the rear reflectance Rᵣ will supplementarily be described.

As an example, a rectangular pulse of the wavelength 1.5 μm and the length 1 ns is assumed and the setting method to obtain a feeble output light containing one photon in one rectangular pulse on average will be considered.

A photon of the wavelength 1.5 μm has energy of 1.3×10⁻¹⁹ J. If the energy is contained in a rectangular pulse of the length 1 ns, the average intensity P_{f} of the rectangular pulse is P_{f}=1.3×10⁻¹⁰ W=0.13 nW. If the intensity Pᵣ of the monitor light is Pᵣ=1.3 mW, the intensity ratio P_{f}/Pᵣ=1.0×10⁻⁷ is obtained. From the above formula (1), the intensity ratio P_{f}/Pᵣ=1.0×10⁻⁷ is satisfied if the front reflectance R_{f}=99.999% and the rear reflectance Rᵣ=0.01% are set.

It is needless to say that the setting method of the front reflectance R_{f} and the rear reflectance Rᵣ is not limited to the above method. That is, any setting method capable of calculating a combination of the front reflectance R_{f} and the rear reflectance Rᵣ satisfying the above formula (1) and the intensity ratio P_{f}/Pᵣ=1.0×10⁻⁷ may be used. However, the above formula (1) has a form that is not easy to use to decide a combination of the front reflectance R_{f} and the rear reflectance Rᵣ. Thus, if the above formula (1) is approximated by noting P_{f}/Pᵣ<<1, 1−R_{f}<<1, and Rᵣ<<1, the following formula (4) is obtained.

$$\begin{matrix}[ Math 2 ] & \\ \sqrt{{R}_{r}} \times ( 1 - {R}_{f} ) = \frac{{P}_{f}}{{P}_{r}} & ( 4 )\end{matrix}$$

In order to obtain a feeble output light containing one photon in one rectangular pulse on average, P_{f}/Pᵣ=1.0×10⁻⁷ may be substituted into the above formula (4) to decide a combination of the front reflectance R_{f} and the rear reflectance Rᵣ satisfying the above formula (4).

The condition of P_{f}/Pᵣ=1.0×10 ⁻⁷ is a condition to set the number of photons contained in one rectangular pulse of feeble output light to one on average when the intensity Pᵣ of monitor light is set as Pᵣ=1.3 mW in the semiconductor laser 11 that outputs a rectangular pulse of the wavelength 1.5 μm and the length 1 ns. Thus, if the wavelength, the shape and length of an optical pulse, or the intensity of monitor light changes, the condition (intensity ratio P_{f}/Pᵣ) for obtaining a feeble output light containing one photon per pulse on average is changed. However, a combination of the front reflectance R_{f} and the rear reflectance Rᵣ capable of obtaining a feeble output light containing one photon per pulse can be obtained by appropriately changing the condition.

In the foregoing, the first embodiment of the present invention has been described. By applying the configuration of the light source unit 1 and the setting method of the front reflectance R_{f} and the rear reflectance Rᵣ according to the present embodiment, a light source of a low-noise stable feeble output light that can be used for quantum encryption communication can be obtained. In addition, the light source unit 1 according to the present embodiment does not have to be provided with an optical attenuation unit (such as the beam splitter 92) separately to obtain a feeble output light. Thus, when compared with the light source system described above and currently in use, the light source unit 1 according to the present embodiment can significantly be reduced in size. Moreover, the intensity of monitor light is high and by using the monitor light to control input energy of the semiconductor laser 11 with high precision, the intensity of the feeble output light can be stabilized.

[2-2: Modification (Configuration Provided with the Optical Attenuator 13)]

Next, the configuration of the light source unit 1 according to a modification of the present embodiment will be described with reference to FIG. 2. FIG. 2 is an explanatory view illustrating the configuration of the light source unit 1 according to a modification of the present embodiment. The same reference numerals are attached to structural elements having substantially the same function as that of elements of the light source unit 1 shown in FIG. 1 to omit a detailed description thereof.

As shown in FIG. 2, the light source unit 1 according to the present modification includes the semiconductor laser 11, the photo-detector 12, and the optical attenuator 13. The semiconductor laser 11 is also provided with the front reflector 111 and the rear reflector 112 as the optical resonator. The reflectance R_{f} (front reflectance R_{f}) of the front reflector 111 is set to be larger than the reflectance Rᵣ (rear reflectance Rᵣ) of the rear reflector 112 (R_{f}>Rᵣ). Thus, a strong light (monitor light) is output from the rear reflector 112 and a weak light (output light) is output from the front reflector 111.

The relation shown in the above formula (1) holds between the intensity Pᵣ of output light and the intensity P_{f} of monitor light by using the front reflectance R_{f} and the rear reflectance Rᵣ. If R_{f}>Rᵣ holds, f(R_{f}^{1/2})>f(Rᵣ^{1/2}) is obtained and it is clear from the above formula (3) that P_{f}/Pᵣ<1 holds. That is, if the front reflectance R_{f} is larger than the rear reflectance Rᵣ (R_{f}>Rᵣ), the intensity P_{f} of output light becomes lower than the intensity Pᵣ of monitor light (P_{f}<Pᵣ). Thus, the light source unit 1 outputs high-intensity monitor light from the rear reflector 112 and low-intensity output light from the front reflector 111.

The monitor light output from the rear reflector 112 enters the photo-detector 12. On the other hand, light output from the front reflector 111 enters the optical attenuator 13. The optical attenuator 13 attenuates the intensity of the light that has entered the optical attenuator 13. As the optical attenuator 13, for example, an optical filter such as an ND filter, a mirror, a polarizing plate, or a combination thereof can be used. The light attenuated by the optical attenuator 13 is extracted from the light source unit 1 as a feeble output light.

The intensity of the feeble output light is adjusted by controlling input energy of the semiconductor laser 11. The light source unit 1 also controls energy input into the semiconductor laser 11 so that the intensity of the feeble output light is stabilized in accordance with the intensity of the monitor light detected by the photo-detector 12. The control of energy input into the semiconductor laser 11 is realized by, for example, controlling the power supply to drive the semiconductor laser 11.

### (Settings of the Reflectance R_{f}, Rᵣ)

The setting method of the front reflectance R_{f} and the rear reflectance Rᵣ will supplementarily be described.

As an example, a rectangular pulse of the wavelength 1.5 μm and the length 1 ns is assumed and the setting method to obtain a feeble output light containing one photon in one rectangular pulse on average will be considered. The optical attenuator 13 is assumed, as an example, an ND filter whose optical density is 4. That is, the transmittance of the optical attenuator 13 is 0.0001=0.01%.

A photon of the wavelength 1.5 μm has energy of 1.3×10⁻¹⁹ J. If the energy is contained in a rectangular pulse of the length 1 ns, the average intensity P_{f} of the rectangular pulse is P_{f}=1.3×10⁻¹⁰ W=0.13 nW. However, the average intensity P_{f} is a numeric value desired to be obtained after passing through the transmittance of 0.01%. Thus, the intensity P_{f} of light prior to the optical attenuator 13 is P_{f}=0.13 nW×10000=1.3 μW.

If the intensity Pᵣ of the monitor light is Pᵣ=1.3 mW, the intensity ratio P_{f}/Pᵣ=1.0×10⁻³ is obtained. From the above approximation (4), the intensity ratio P_{f}/Pᵣ=1.0×10⁻³ is satisfied if the front reflectance R_{f}=99% and the rear reflectance R_{f}=1% are set. To be more precise, if the front reflectance R_{f}=99% and the rear reflectance Rᵣ=1% are assumed, the intensity ratio P_{f}/Pᵣ is obtained as P_{f}/Pᵣ= 1/985 from the above formula (1). Then, the intensity Pᵣ of the monitor light is obtained as Pᵣ=1.3 mW×0.985=1.28 mW.

If P_{f}/Pᵣ=1.0×10⁻³ is substituted into the above formula (1) the relation of the front reflectance R_{f} and the rear reflectance Rᵣ is like a graph shown in FIG. 3.

That is, if one point on the graph shown in FIG. 3 is selected and the combination of the front reflectance R_{f} and the rear reflectance Rᵣ is selected, P_{f}/Pᵣ=1.0×10⁻³ is obtained. In other words, if the front reflectance R_{f} and the rear reflectance Rᵣ corresponding to the graph in FIG. 3 are set and input energy of the semiconductor laser 11 is controlled so that the optical intensity of monitor light detected by the photo-detector 12 becomes 1.3 mW in the light source unit 1 shown in FIG. 2, a feeble output light containing one photon in one rectangular pulse on average can be extracted.

The condition of P_{f}/Pᵣ=1.0×10⁻³ is a condition to set the number of photons contained in one rectangular pulse of feeble output light to one on average when the intensity Pᵣ of monitor light is set as Pᵣ=1.3 mW and the transmittance of the ND filter is 0.01% in the semiconductor laser 11 that outputs a rectangular pulse of the wavelength 1.5 μm and the length 1 ns. Thus, if the wavelength, the shape and length of an optical pulse, the intensity of monitor light, or the transmittance of the ND filter changes, the condition (intensity ratio P_{f}/Pᵣ) for obtaining a feeble output light containing one photon per pulse on average is changed. However, a combination of the front reflectance R_{f} and the rear reflectance Rᵣ capable of obtaining a feeble output light containing one photon per pulse can be obtained by appropriately changing the condition.

In the foregoing, a modification of the first embodiment of the present invention has been described. By applying the configuration of the light source unit 1 and the setting method of the front reflectance R_{f} and the rear reflectance Rᵣ according to the present modification, a light source of a low-noise stable feeble output light that can be used for quantum encryption communication can be obtained. In addition, the light source unit 1 according to a modification of the present embodiment does not have to be provided with an optical attenuation unit (such as the beam splitter 92) separately to obtain a feeble output light. Thus, when compared with the light source system described above and currently in use, the light source unit 1 according to the present embodiment can significantly be reduced in size. Moreover, the intensity of monitor light is high and thus, the monitor light can be used to control input energy of the semiconductor laser 11 with high precision and so the intensity of the feeble output light can be stabilized.

The light source unit 1 according to the present modification uses the optical attenuator 13 and thus, when compared with the light source unit 1 shown in FIG. 1, the front reflectance R_{f} can be made larger and the rear reflectance Rᵣ can be made smaller. As a result, when compared with the light source unit 1 shown in FIG. 1, the front reflector 111 and the rear reflector 112 can be manufactured more easily, contributing to the reduction of manufacturing costs.

### 3. Second Embodiment

### Application of the Controller 14

The second embodiment of the present invention will be described.

### [3-1: Configuration of the Light Source Unit 1]

First, the configuration of the light source unit 1 according to the present embodiment will be described with reference to FIG. 4. FIG. 4 is an explanatory view illustrating the configuration of the light source unit 1 according to the present embodiment. The same reference numerals are attached to structural elements having substantially the same function as that of elements of the light source unit 1 shown in FIG. 1 to omit a detailed description thereof.

As shown in FIG. 4, the light source unit 1 according to the present embodiment includes the semiconductor laser 11, the photo-detector 12, and the controller 14. The semiconductor laser 11 is also provided with the front reflector 111 and the rear reflector 112 as an optical resonator. The reflectance R_{f} (front reflectance R_{f}) of the front reflector 111 is set to be larger than the reflectance Rᵣ (rear reflectance Rᵣ) of the rear reflector 112 (R_{f}>Rᵣ). Thus, a strong light (monitor light) is output from the rear reflector 112 and a weak light (output light) is output from the front reflector 111.

The relation shown in the above formula (1) holds between the intensity Pᵣ of output light and the intensity P_{f} of monitor light by using the front reflectance R_{f} and the rear reflectance R_{f}. If R_{f}>Rᵣ holds, f(R_{f}^{1/2})>f(Rᵣ^{1/2}) is obtained and it is clear from the above formula (3) that P_{f}/Pᵣ<1 holds. That is, if the front reflectance R_{f} is larger than the rear reflectance Rᵣ (R_{f}>Rᵣ), the intensity P_{f} of output light becomes lower than the intensity Pᵣ of monitor light (P_{f}<Pᵣ). Thus, the light source unit 1 outputs high-intensity monitor light from the rear reflector 112 and low-intensity output light from the front reflector 111.

The monitor light output from the rear reflector 112 enters the photo-detector 12. On the other hand, light output from the front reflector 111 is extracted from the light source unit 1 as a feeble output light. The intensity of the feeble output light is controlled by the controller 14. The controller 14 is configured by using a semiconductor chip or processing unit. The photo-detector 12 and the controller 14 may be produced on the same semiconductor substrate as a semiconductor device.

The intensity (hereinafter, referred to as an intensity measured value) of the monitor light detected by the photo-detector 12 is input into the controller 14. If the intensity measured value is input, the controller 14 determines the amount of input energy of the semiconductor laser 11 based on the input intensity measured value. The controller 14 that has determined the amount of input energy inputs a control signal (hereinafter, referred to as an input energy control signal) to exercise control so that energy of the amount of input energy is input into the semiconductor laser 11. If the input energy control signal is input, the semiconductor laser 11 inputs energy corresponding to the input energy control signal into the laser medium.

Thus, the light source unit 1 according to the present embodiment controls input energy of the semiconductor laser 11 in accordance with the intensity of monitor light. Particularly, to stabilize the intensity of feeble output light, the controller 14 determines the amount of input energy so that the intensity of monitor light becomes a predetermined value. As a result, a feeble output light output from the semiconductor laser 11 has stable intensity. For the light source unit 1, the intensity of monitor light is high. Thus, the intensity of monitor light can be detected with high precision. As a result, energy input into the semiconductor laser 11 can be controlled with high precision so that the intensity of feeble output light can be stabilized with high precision.

The setting method of the front reflectance R_{f} and the rear reflectance Rᵣ is the same as in the first embodiment and thus, the description thereof is omitted.

In the foregoing, the second embodiment of the present invention has been described. By applying the configuration of the light source unit 1 according to the present embodiment, a light source of a low-noise stable feeble output light that can be used for quantum encryption communication can be obtained. In addition, the light source unit 1 according to the present embodiment does not have to be provided with an optical attenuation unit (such as the beam splitter 92) separately to obtain a feeble output light. Thus, when compared with the light source system described above and currently in use, the light source unit 1 according to the present embodiment can significantly be reduced in size.

Moreover, the intensity of monitor light is high and thus, the monitor light can be used to control input energy of the semiconductor laser 11 with high precision and so the intensity of the feeble output light can be stabilized. Further, in the present embodiment, the controller 14 is contained in the light source unit 1 and thus, there is no need to externally set up a drive power supply of the semiconductor laser 11 as a unit to control input energy. As a result, when compared with the light source unit 1 shown in FIG. 1, a still smaller light source system can be realized.

[3-2: Modification (Configuration Provided with the Optical Attenuator 13)]

Next, the configuration of the light source unit 1 according to a modification of the present embodiment will be described with reference to FIG. 5. FIG. 5 is an explanatory view illustrating the configuration of the light source unit 1 according to a modification of the present embodiment. The same reference numerals are attached to structural elements having substantially the same function as that of elements of the light source unit 1 shown in FIGS. 2 and 4 to omit a detailed description thereof.

As shown in FIG. 5, the light source unit 1 according to the present embodiment includes the semiconductor laser 11, the photo-detector 12, the optical attenuator 13, and the controller 14. The semiconductor laser 11 is also provided with the front reflector 111 and the rear reflector 112 as an optical resonator. The reflectance R_{f} (front reflectance R_{f}) of the front reflector 111 is set to he larger than the reflectance Rᵣ (rear reflectance Rᵣ) of the rear reflector 112 (R_{f}>Rᵣ). Thus, a strong light (monitor light) is output from the rear reflector 112 and a weak light (output light) is output from the front reflector 111.

The relation shown in the above formula (1) holds between the intensity Pᵣ of output light and the intensity P_{f} of monitor light by using the front reflectance R_{f} and the rear reflectance Rᵣ. If R_{f}>Rᵣ holds, f(R_{f}^{1/2})>f(Rᵣ^{1/2}) is obtained and it is clear from the above formula (3) that P_{f}/Pᵣ<1 holds. That is, if the front reflectance R_{f} is larger than the rear reflectance Rᵣ (R_{f}>Rᵣ), the intensity P_{f} of output light becomes lower than the intensity Pᵣ of monitor light (P_{f}<Pᵣ). Thus, the light source unit 1 outputs high-intensity monitor light from the rear reflector 112 and low-intensity output light from the front reflector 111.

The monitor light output from the rear reflector 112 enters the photo-detector 12. On the other hand, light output from the front reflector 111 enters the optical attenuator 13. The optical attenuator 13 attenuates the intensity of the light that has entered the optical attenuator 13. As the optical attenuator 13, for example, an optical filter such as an ND filter, a mirror, a polarizing plate, or a combination thereof can be used. The light attenuated by the optical attenuator 13 is extracted from the light source unit 1 as a feeble output light. The intensity of the feeble output light is controlled by the controller 14. The controller 14 is configured by using a semiconductor chip or processing unit. The photo-detector 12 and the controller 14 may be produced on the same semiconductor substrate as a semiconductor device.

The intensity (intensity measured value) of the monitor light detected by the photo-detector 12 is input into the controller 14. If the intensity measured value is input, the controller 14 determines the amount of input energy of the semiconductor laser 11 based on the input intensity measured value. The controller 14 that has determined the amount of input energy inputs a control signal (input energy control signal) to exercise control so that energy of the amount of input energy is input into the semiconductor laser 11. If the input energy control signal is input, the semiconductor laser 11 inputs energy corresponding to the input energy control signal into the laser medium.

Thus, the light source unit 1 according to the present embodiment controls input energy of the semiconductor laser 11 in accordance with the intensity of monitor light. Particularly, to stabilize the intensity of feeble output light, the controller 14 determines the amount of input energy so that the intensity of monitor light becomes a predetermined value. As a result, a feeble output light output from the semiconductor laser 11 has stable intensity. For the light source unit 1, the intensity of monitor light is high. Thus, the intensity of monitor light can be detected with high precision. As a result, energy input into the semiconductor laser 11 can be controlled with high precision so that the intensity of feeble output light can be stabilized with high precision.

The setting method of the front reflectance R_{f} and the rear reflectance Rᵣ is the same as in the modification according to the first embodiment and thus, the description thereof is omitted.

In the foregoing, a modification of the second embodiment of the present invention has been described. By applying the configuration of the light source unit 1 according to the present embodiment, a light source of a low-noise stable feeble output light that can be used for quantum encryption communication can be obtained. In addition, the light source unit 1 according to the present embodiment does not have to be provided with an optical attenuation unit (such as the beam splitter 92) separately to obtain a feeble output light. Thus, when compared with the light source system described above and currently in use, the light source unit 1 according to the present embodiment can significantly be reduced in size.

Moreover, the intensity of monitor light is high and thus, the monitor light can be used to control input energy of the semiconductor laser 11 with high precision and so the intensity of the feeble output light can be stabilized. The light source unit 1 according to the present modification uses the optical attenuator 13 and thus, when compared with the light source unit 1 shown in FIG. 4, the front reflectance R_{f} can be made larger and the rear reflectance Rᵣ can be made smaller. As a result, when compared with the light source unit 1 shown in FIG. 4, the front reflector 111 and the rear reflector 112 can be manufactured more easily, contributing to the reduction of manufacturing costs.

### 4. Third Embodiment

### Application of the Variable Optical Attenuator 15

The third embodiment of the present invention will be described.

### [4-1: Configuration of the Light Source Unit 1]

First, the configuration of the light source unit 1 according to the present embodiment will be described with reference to FIG. 6. FIG. 6 is an explanatory view illustrating the configuration of the light source unit 1 according to the present embodiment. The same reference numerals are attached to structural elements having substantially the same function as that of elements of the light source unit 1 shown in FIG. 5 to omit a detailed description thereof.

As shown in FIG. 6, the light source unit 1 according to the present embodiment includes the semiconductor laser 11, the photo-detector 12, the controller 14, and the variable optical attenuator 15. The semiconductor laser 11 is also provided with the front reflector 111 and the rear reflector 112 as an optical resonator. The reflectance R_{f} (front reflectance R_{f}) of the front reflector 111 is set to be larger than the reflectance Rᵣ (rear reflectance Rᵣ) of the rear reflector 112 (R_{f}>Rᵣ). Thus, a strong light (monitor light) is output from the rear reflector 112 and a weak light (output light) is output from the front reflector 111.

The relation shown in the above formula (1) holds between the intensity Pᵣ of output light and the intensity P_{f} of monitor light by using the front reflectance R_{f} and the rear reflectance Rᵣ. If R_{f}>Rᵣ holds, f(R_{f}^{1/2})>f(Rᵣ^{1/2}) is obtained and it is clear from the above formula (3) that P_{f}/Pᵣ<1 holds. That is, if the front reflectance R_{f} is larger than the rear reflectance Rᵣ (R_{f}>Rᵣ), the intensity P_{f} of output light becomes lower than the intensity Pᵣ of monitor light (P_{f}<Pᵣ). Thus, the light source unit 1 outputs high-intensity monitor light from the rear reflector 112 and low-intensity output light from the front reflector 111.

The monitor light output from the rear reflector 112 enters the photo-detector 12. On the other hand, light output from the front reflector 111 enters the variable optical attenuator 15. The variable optical attenuator 15 attenuates the intensity of the light that has entered the variable optical attenuator 15. However, in contrast to the optical attenuator 13 in which the magnitude of attenuation is fixed, the variable optical attenuator 15 can switch the magnitude of attenuation under the control of the controller 14. For example, the variable optical attenuator 15 can switch the magnitude of attenuation between a first magnitude of attenuation to obtain a feeble output light that can be used for quantum encryption communication and a second magnitude of attenuation to obtain a light (hereinafter, referred to as a non-feeble output light) having intensity higher than that of the feeble output light.

The non-feeble output light can be used as, for example, a light source of common optical communication to control electronic devices or to transmit/receive various kinds of data or a light source of a laser pointer. The variable optical attenuator 15 is configured, as shown, for example, in FIG. 7, by combining a liquid crystal device 151 and a polarizing plate 152. The liquid crystal device 151 is arranged prior to the polarizing plate 152 so that the light output from the semiconductor laser 11 enters the liquid crystal device 151 and the light having passed through the liquid crystal device 151 enters the polarizing plate 152. If the semiconductor laser 11 outputs horizontally polarized light, the polarizing plate 152 is set up so that the horizontally polarized light is transmitted.

If such a configuration is adopted, light output from the semiconductor laser 11 does not pass through the polarizing plate 152 as long as the polarization direction is not changed by the liquid crystal device 151. Moreover, the intensity of light passing through the polarizing plate 152 changes in accordance with the extent of change of the polarization direction changed by the liquid crystal device 151. The extent of change of the polarization direction increases with an increasing voltage applied to the liquid crystal device 151. That is, the intensity of light output from the polarizing plate 152 can be controlled by controlling the voltage applied to the liquid crystal device 151.

As described above, the magnitude of attenuation for the variable optical attenuator 15 is controlled by the controller 14. If, for example, the light output from the variable optical attenuator 15 is set to a feeble output light, the controller 14 inputs, to the variable optical attenuator 15, a signal (hereinafter, referred to as an optical attenuation magnitude control signal) to control the voltage applied to the liquid crystal device 151 so that the magnitude of attenuation of the variable optical attenuator 15 is set to the first magnitude of attenuation. On the other hand, if the light output from the variable optical attenuator 15 is set to a non-feeble output light, the controller 14 inputs, to the variable optical attenuator 15, an optical attenuation magnitude control signal to control the voltage applied to the liquid crystal device 151 so that the magnitude of attenuation of the variable optical attenuator 15 is set to the second magnitude of attenuation. With the optical attenuation magnitude control signal being input from the controller 14 as described above, the magnitude of attenuation of the variable optical attenuator 15 is controlled.

The light attenuated by the above variable optical attenuator 15 is extracted from the light source unit 1 as a feeble output light or non-feeble output light. The intensity of the feeble output light or non-feeble output light is controlled by the controller 14. The controller 14 is configured by using a semiconductor chip or processing unit. The photo-detector 12 and the controller 14 may be produced on the same semiconductor substrate as a semiconductor device.

The intensity (intensity measured value) of the monitor light detected by the photo-detector 12 is input into the controller 14. If the intensity measured value is input, the controller 14 determines the amount of input energy of the semiconductor laser 11 based on the input intensity measured value. The controller 14 that has determined the amount of input energy inputs a control signal (input energy control signal) to exercise control so that energy of the amount of input energy is input into the semiconductor laser 11. If the input energy control signal is input, the semiconductor laser 11 inputs energy corresponding to the input energy control signal into the laser medium.

Thus, the light source unit 1 according to the present embodiment controls input energy of the semiconductor laser 11 in accordance with the intensity of monitor light. Particularly, to stabilize the intensity of feeble output light, the controller 14 determines the amount of input energy so that the intensity of monitor light becomes a predetermined value. As a result, the feeble output light or non-feeble output light output from the semiconductor laser 11 has stable intensity. For the light source unit 1, the intensity of monitor light is high. Thus, the intensity of monitor light can be detected with high precision. As a result, energy input into the semiconductor laser 11 can be controlled with high precision so that the intensity of feeble output light or non-feeble output light can be stabilized with high precision.

The setting method of the front reflectance R_{f} and the rear reflectance Rᵣ is the same as in the modification according to the first embodiment and thus, the description thereof is omitted.

In the foregoing, the third embodiment of the present invention has been described. By applying the configuration of the light source unit 1 according to the present embodiment, a light source of a low-noise stable feeble output light that can be used for quantum encryption communication can be obtained. In addition, the light source unit 1 according to the present embodiment does not have to be provided with an optical attenuation unit (such as the beam splitter 92) separately to obtain a feeble output light. Thus, when compared with the light source system described above and currently in use, the light source unit 1 according to the present embodiment can significantly be reduced in size.

Moreover, the intensity of monitor light is high and thus, the monitor light can be used to control input energy of the semiconductor laser 11 with high precision and so the intensity of the feeble output light can be stabilized. The light source unit 1 according to the present modification uses the variable optical attenuator 15 and thus, when compared with the light source unit 1 shown in FIG. 4, the front reflectance R_{f} can be made larger and the rear reflectance Rᵣ can be made smaller.

As a result, when compared with the light source unit 1 shown in FIG. 4, the front reflector 111 and the rear reflector 112 can be manufactured more easily, contributing to the reduction of manufacturing costs.

Further, the light source unit 1 according to the present invention can switch the magnitude of attenuation of light output from the semiconductor laser 11 by controlling the variable optical attenuator 15 and thus, a feeble output light and a non-feeble output light can be used for different uses by the same apparatus. Also, by configuring the variable optical attenuator 15 by the liquid crystal device 151 and the polarizing plate 152, a feeble output light and a non-feeble output light can be switched by an easy operation of controlling the voltage of the liquid crystal device 151. As a result, the small-sized light source unit 1 playing both roles of a feeble output light source and a non-feeble output light source can be realized.

### [4-2: Concrete Application Examples of the Light Source Unit 1]

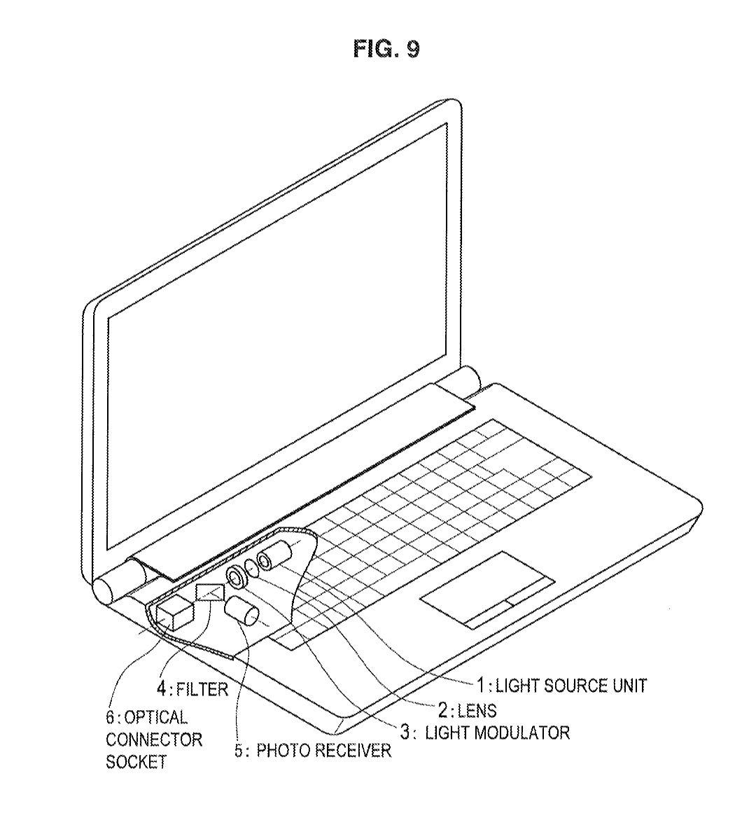

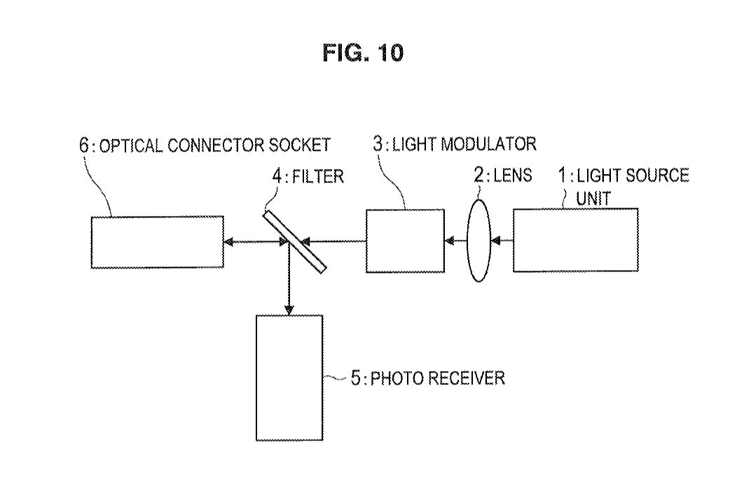

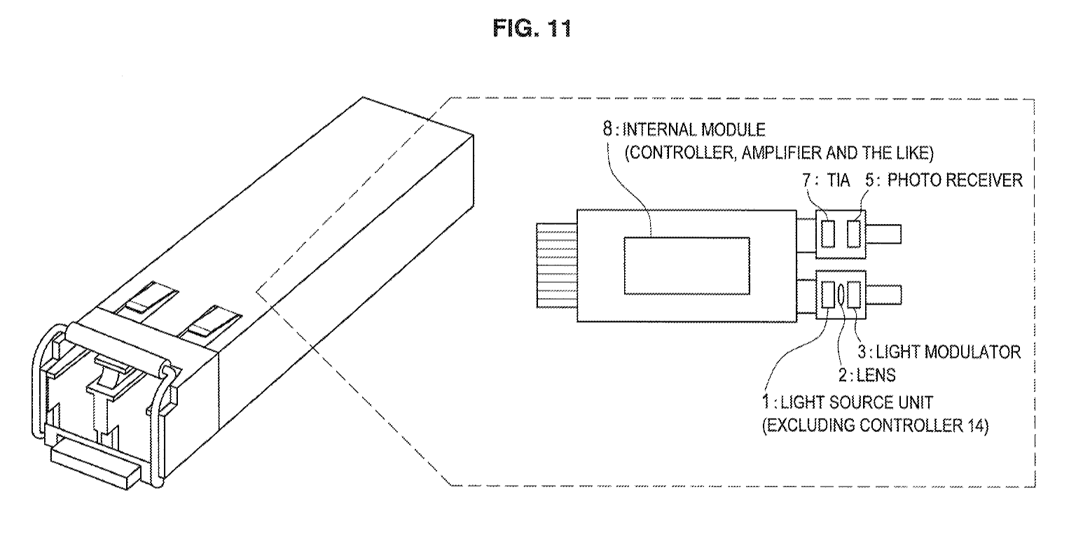

Concrete application examples of the light source unit 1 shown in FIG. 6 will be described with reference to FIGS. 8 to 11. FIG. 8 shows an application example to a mobile phone. FIGS. 9 and 10 shows an application example to a notebook computer. FIG. 11 shows an application example to a communication module of the type called an SFP (Small Form factor Pluggable) module. The communication module is an interface module called an optical transceiver mounted on a communication device using optical fiber such as Gigabit Ethernet (registered trademark), fiber channel, and STM (Synchronous Transport Module). However, the application range of the light source unit 1 shown in FIG. 6 is not limited to these examples.

(1) When applied to a mobile phone, the mobile phone will be mounted with, as shown, for example, in FIG. 8, the light source unit 1, a lens 2, and a light modulator 3. The light source unit 1 is the one shown in FIG. 6. The lens 2 converges light output from the light source unit 1 so that the light enters the light modulator 3. Then, the light modulator 3 modulates the polarization direction, phase and the like of the light that has entered the light modulator 3. In this case, the light output from the light source unit 1 enters the light modulator 3 via the lens 2 and is extracted from the mobile phone after being modulated by the light modulator 3.

(2) When applied to a notebook computer, the notebook computer will be mounted with, as shown, for example, in FIG. 9, the light source unit 1, the lens 2, the light modulator 3, a filter 4, a photo receiver 5, and an optical connector socket 6. The configuration of components mounted on the notebook computer is as shown in FIG. 10. The light source unit 1 is the one shown in FIG. 6. The lens 2 converges light output from the light source unit 1 so that the light enters the light modulator 3. Then, the light modulator 3 modulates the polarization direction, phase and the like of the light that has entered the light modulator 3. First, light output from the light source unit 1 enters the light modulator 3 via the lens 2. Next, the light modulated by the light modulator 3 enters the filter 4.

The filter 4 guides light output from the light source unit 1 to the optical connector socket 6 and, on the other hand, plays a role of an optical separator that guides light entering from outside through the optical connector socket 6 to the photo receiver 5. Thus, the light modulated by the light modulator 3 enters the optical connector socket 6 via the filter 4. The light that has entered the optical connector socket 6 is extracted to the outside through an optical cable connected to the optical connector socket 6. On the other hand, light entering from outside through the optical cable connected to the optical connector socket 6 enters the photo receiver 5 via the filter 4. The photo receiver 5 receives the incident light. As the photo receiver 5, for example, a semiconductor light-receiving element such as a photodiode is used.

It is assumed here a situation in which communication is performed in both directions by a single optical cable. Normally, in bidirectional communication using an optical cable, the wavelength of light used for transmission and the wavelength of light used for reception are different. Thus, as described above, light having different wavelengths can be separated by using the filter 4. It is needless to say that the configuration of the filter 4, the photo receiver 5, and the optical connector socket 6 may suitably be modified in accordance with the type or form of communication functions mounted on the notebook computer. Moreover, a partial change of the design such as the incorporation of the lens 2 into the light source unit 1 is permitted.

(3) When applied to an optical transceiver, the optical transceiver will be mounted with, as shown, for example, in FIG. 11, the light source unit 1, the lens 2, the light modulator 3, the photo receiver 5, a TIA7 (TransImpedance Amplifier), and an internal module 8. The light source unit 1 is the one shown in FIG. 6. When applied to an optical transceiver, the controller 14 mounted on the light source unit 1 may be incorporated into the internal module 8.

Like when applied to a mobile phone, the lens 2 converges light output from the light source unit 1 so that the light enters the light modulator 3. Then, the light modulator 3 modulates the polarization direction, phase and the like of the light that has entered the light modulator 3. In this case, the light output from the light source unit 1 enters the light modulator 3 via the lens 2 and is extracted through an optical cable connected to a transmitting side socket of the optical transceiver after being modulated by the light modulator 3.

Light entering from outside through the optical cable connected to the transmitting side socket of the optical transceiver is received by the photo receiver 5. The light received by the photo receiver 5 is photoelectrically converted inside the photo receiver 5. A low-level current output from the photo receiver 5 is input into the TIA 7 and converted into a voltage signal before being output to the internal module 8. Thus, the optical transceiver is provided with one optical cable on each of the transmitting side and the receiving side. Therefore, the light source unit 1 is provided on a communication path to the optical cable on the transmitting side.

As described above, the light source unit 1 according to the present embodiment can be applied to various devices. A data transmitting unit (not shown) to transmit data by using the light source unit 1 is connected to or set up in a device to which the light source unit 1 can be applied.

### CONCLUSION

Lastly, technical content according to the embodiments of the present invention will briefly be summarized. Technical content described here is applied to a light source unit that can be incorporated into various information processing apparatuses such as a PC, mobile phone, mobile game machine, mobile information terminal, home electronic appliance, and car navigation system.

The function configuration of the above light source unit can be expressed as follows. The light source unit includes a first reflector, second reflector, laser medium, and excitation source. The first reflector has the reflectance R₁. The second reflector arranged opposite to the first reflector has the reflectance R₂ (R₂<R₁). Further, the laser medium is arranged between the first and second reflectors. Then, the excitation source is provided to excite the laser medium. That is, the light source unit relates to a laser light source on which an optical resonator having asymmetric reflectance is mounted. Further, the reflectance R₁ of the first reflector is set in such a way that the number of photons of laser light having passed through the first reflector is one per pulse.

Output of feeble light to such an extent that the number of photons per optical pulse is one or less is demanded from a light source used for quantum encryption communication. However, the intensity of light that can be output from many laser light sources is higher than the intensity of feeble light used for quantum encryption communication and thus, it is necessary to provide an optical attenuation unit outside the laser light source. As the optical attenuation unit, for example, a mirror of a high reflectance or a filter of high optical density is used. However, the light source unit according to the embodiments of the present invention uses light output from the first reflector of a high reflectance as an output light. Thus, if the light source unit is applied, there is no need to provide an optical attenuation unit outside. As a result, the light source unit can also be mounted on small devices such as a mobile phone, notebook computer, and communication module.

To be noted here is the fact that it is very difficult to obtain an output light of feeble intensity that can be used for quantum encryption communication by weakening energy input into a laser medium. Generally, light output from a laser light source contains, in addition to laser light (stimulated emission light), spontaneous emission light. The ratio of spontaneous emission light increases with decreasing energy input into the laser medium. Thus, if energy input into the laser medium is decreased, the ratio of spontaneous emission light increases, leading to unstable laser oscillation or no laser oscillation. Further, the ratio of spontaneous emission light serving as noise for laser light increases and thus, quality of feeble output light is substantially degraded.

Due to such an intrinsic problem specific to a laser light source, it is very difficult to obtain a feeble output light by weakening energy input into a laser medium. On the other hand, instead of weakening energy input into a laser medium, the above light source unit adjusts the reflectance R1 of the first reflector constituting an optical resonator. Light passing through the first reflector and the second reflector is attenuated by approximately the same ratio regardless of whether the light is laser light or spontaneous emission light. That is, spontaneous emission light is also attenuated when passing through the first reflector and thus, if the ratio of laser light contained in the light output from the laser light source is sufficiently high, a high-quality feeble output light is obtained from the first reflector. Therefore, when compared with the method of narrowing down input energy, a light source unit according to the embodiments of the present invention is superior in principle. Moreover, the system to obtain a feeble output light can significantly be reduced in size.

### (Note)

The front reflector 111 is an example of the first reflector. The rear reflector 112 is an example of the second reflector. The semiconductor laser is an example of the laser light source obtained by combining a laser medium and an excitation source. The mobile phone, notebook computer, and communication module are examples of the communication apparatus.

The preferred embodiments of the present invention have been described above with reference to the accompanying drawings, whilst the present invention is not limited to the above examples, of course. A person skilled in the art may find various alternations and modifications within the scope of the appended claims, and it should be understood that they will naturally come under the technical scope of the present invention.

In the description of the above embodiments, a semiconductor laser is taken as an example of the laser light source. Though the semiconductor laser is preferable from the viewpoint of miniaturization, any solid-state laser may be used, instead of the semiconductor laser.

### REFERENCE SIGNS LIST

1 Light source unit

2 Lens

3 Light modulator

4 Filter

5 Photo receiver

6 Optical connector socket

7 TIA

8 Internal module

11 Semiconductor laser

12 Photo-detector

13 Optical attenuator

14 Controller

15 Variable optical attenuator

111 Front reflector

112 Rear reflector

151 Liquid crystal device

152 Polarizing plate

1. A light source unit, comprising:
a first reflector having a reflectance R₁;
a second reflector arranged opposite to the first reflector and having a reflectance R₂ (R₂<R₁);
a laser medium arranged between the first reflector and the second reflector; and
an excitation source to excite the laser medium,
wherein the reflectance R₁ is set in such a way that the number of photons of laser light having passed through the first reflector is one per pulse.

2. A light source unit, comprising:
a first reflector having a reflectance R₁;
a second reflector arranged opposite to the first reflector and having a reflectance R₂ (R₂<R₁);
a laser medium arranged between the first reflector and the second reflector;
an excitation source to excite the laser medium; and
an optical attenuator that causes laser light having passed through the first reflector to attenuate,
wherein the reflectance R₁ is set in such a way that the number of photons of the laser light attenuated by the optical attenuator is one per pulse.

3. A light source unit, comprising:
a first reflector having a reflectance R₁;
a second reflector arranged opposite to the first reflector and having a reflectance R₂ (R₂<R₁);
a laser medium arranged between the first reflector and the second reflector;
an excitation source to excite the laser medium;
a photo-detector that detects intensity of laser light having passed through the second reflector; and
a controller that controls the excitation source to adjust excitation intensity for the laser medium based on the intensity of the laser light detected by the photo-detector in such a way that the number of photons of the laser light having passed through the first reflector is one per pulse.

4. A light source unit, comprising:
a first reflector having a reflectance R₁;
a second reflector arranged opposite to the first reflector and having a reflectance R₂ (R₂<R₁);
a laser medium arranged between the first reflector and the second reflector;
an excitation source to excite the laser medium;
an optical attenuator that causes laser light having passed through the first reflector to attenuate;
a photo-detector that detects intensity of the laser light having passed through the second reflector; and
a controller that controls the excitation source to adjust excitation intensity for the laser medium based on the intensity of the laser light detected by the photo-detector in such a way that the number of photons of the laser light attenuated by the optical attenuator is one per pulse.

5. A light source unit, comprising:
a first reflector having a reflectance R₁;
a second reflector arranged opposite to the first reflector and having a reflectance R₂ (R₂<R₁);
a laser medium arranged between the first reflector and the second reflector;
an excitation source to excite the laser medium;
an optical attenuator that causes laser light having passed through the first reflector to attenuate;
a photo-detector that detects intensity of the laser light having passed through the second reflector; and
a controller that controls a magnitude of attenuation of the laser light by the optical attenuator to a first magnitude of attenuation in which the number of photons of the laser light attenuated by the optical attenuator is one per pulse or a second magnitude of attenuation that is different from the first magnitude of attenuation based on the intensity of the laser light detected by the photo-detector.

6. The light source unit according to claim 1,
wherein the laser medium is a laser medium of a semiconductor laser.

7. The light source unit according to claim 2,
wherein the laser medium is a laser medium of a semiconductor laser.

8. The light source unit according to claim 3,
wherein the laser medium is a laser medium of a semiconductor laser.

9. The light source unit according to claim 4,
wherein the laser medium is a laser medium of a semiconductor laser.

10. The light source unit according to claim 5,
wherein the laser medium is a laser medium of a semiconductor laser.

11. The light source unit according to claim 6,
wherein an optical resonator configured by the first and second reflectors is formed of a Fabry-Perot resonator, and
one or both of the first and second reflectors are semiconductor end faces coated with a dielectric film.

12. The light source unit according to claim 6,
wherein an optical resonator configured by the first and second reflectors is a distributed feedback resonator or a distributed Bragg reflection resonator.

13. The light source unit according to claim 6,
wherein an optical resonator configured by the first and second reflectors is a multilayer mirror resonator, and
the semiconductor laser is a surface light emitting laser.

14. The light source unit according to claim 6,
wherein the photo-detector is a semiconductor light-receiving element.

15. The light source unit according to claim 6,
wherein the optical attenuator is an optical filter, a partial reflection mirror, or a combination of the optical filter and the partial reflection mirror.

16. The light source unit according to claim 5,
wherein the laser medium outputs the laser light linearly polarized in a first polarization direction,
the optical attenuator includes:
a liquid crystal device that changes a polarization direction of the laser light output from the laser medium to an extent of change in accordance with an applied voltage; and
a polarizing plate that transmits light in a second polarization direction perpendicular to the first polarization direction,
the light having passed through the liquid crystal device enters the polarizing plate, and
the controller controls a magnitude of attenuation of the laser light by the optical attenuator by controlling the voltage applied to the liquid crystal device.

17. A communication apparatus, comprising:
a light source unit including
a first reflector having a reflectance R₁,
a second reflector arranged opposite to the first reflector and having a reflectance R₂ (R₂<R₁),
a laser medium arranged between the first reflector and the second reflector, and
an excitation source to excite the laser medium; and
a data transmitting unit that transmits data by using the light source unit,
wherein the reflectance R₁ is set in such a way that the number of photons of laser light having passed through the first reflector is one per pulse.
